(19) United States
(12) Patent Application Publication
(10) Pub. No.: US 2022/0111954 A1
(43) Pub. Date: Apr. 14, 2022

(54) DUCTED FAN OF AN AIRCRAFT, AIRCRAFT, AND COMPONENT THEREOF

(71) Applicant: Dr. Ing. h.c. F. Porsche Aktiengesellschaft, Stuttgart (DE)

(72) Inventors: Patrick Scholl, Bietigheim-Bissingen (DE); Jens-Ole Thoebel, Hankensbuettel (DE); Christian Wenzel, Untergruppenbach (DE)

(21) Appl. No.: 17/499,964

(22) Filed: Oct. 13, 2021

(30) Foreign Application Priority Data
Oct. 14, 2020 (DE) 10 2020 127 034.8

(51) Int. Cl. B64C 27/20; B32B 27/08; B32B 3/12; B32B 3/18; B32B 27/18; B32B 1/08; B32B 3/06

(52) U.S. Cl. CPC B64C 27/20; B32B 27/08; B32B 3/12; B32B 3/18; B32B 27/18; B32B 2597/00; B32B 3/06; B32B 2605/18; B32B 2262/101; B32B 2262/106; B32B 1/08

(57) ABSTRACT

A ducted fan for an aircraft includes a rotor-side fan and a stator-side duct that surrounds the rotor-side fan. The stator-side duct includes an inner wall facing the rotor-side fan and an outer wall averted from the fan. The inner wall and outer wall each includes at least one layer composed of fiber-reinforced plastic. At least two honeycomb cores are arranged between the inner wall and the outer wall, the at least two honeycomb cores abutting against one another in an axial direction of the ducted fan. The honeycombs of the at least two honeycomb cores extend at least substantially in a radial direction of the ducted fan. A first of the at least two honeycomb cores is, at least in a region of an abutting surface that adjoins another of the at least two honeycomb cores, enwound or encased by at least one layer composed of fiber-reinforced plastic.

### CROSS REFERENCE TO RELATED APPLICATIONS

This application claims benefit to German Patent Application No. DE 10 2020 127 034.8, filed on Oct. 14, 2020, which is hereby incorporated by reference herein.

### FIELD

The disclosure relates to a ducted fan of an aircraft and to an aircraft. The disclosure further relates to a component of an aircraft.

### BACKGROUND

DE 10 2018 116 144 A1 discloses an aircraft having a fuselage and having wings which engage on the fuselage. Ducted fans are integrated into the wings. The ducted fans can be covered by slats. The ducted fans may be horizontally or vertically fixed. Horizontally fixed ducted fans serve for the propulsion of the aircraft during a vertical takeoff or a vertical landing. Vertically fixed ducted fans serve for generating forward thrust for the aircraft.

DE 10 2018 123 470 A1 has disclosed an aircraft in the case of which multiple ducted fans are integrated into a wing.

DE 10 2018 116 147 A1 has disclosed a further aircraft. Here, fans which assist the vertical takeoff or a vertical landing of the aircraft engage on a nose of the fuselage of the aircraft.

DE 10 2018 116 153 A1 has disclosed an aircraft in which ducted fans engage on a fuselage, specifically the nose of the fuselage, of the aircraft. Here, two ducted fans are combined to form a unit which is pivotable about an axis of rotation, wherein said axis of rotation runs parallel to a pitch axis of the aircraft.

DE 10 2018 116 166 A1 discloses the basic construction of a ducted fan of an aircraft. According thereto, a ducted fan comprises a rotor-side fan, also referred to as rotor, and a stator-side duct, wherein the duct surrounds the fan radially at the outside. The duct defines a flow channel, extending in an axial direction, for air flowing via the fan.

DE 10 2018 116 149 A1 has disclosed a further ducted fan of an aircraft.

DE 10 2018 120 200 A1 also discloses a ducted fan of an aircraft. In the case of this ducted fan, an electric machine is integrated into the duct.

A ducted fan of an aircraft should be of the most lightweight construction possible. Furthermore, a ducted fan of an aircraft must have sufficient stability and stiffness. It has hitherto proven difficult to completely satisfy both requirements.

DE 10 2008 060 550 B3 has disclosed a floor panel of an aircraft which has a honeycomb structure and two outer surface layers for the honeycomb structure. The honeycomb structure and the two surface layers form a sandwich component. The honeycomb structure is composed of plastic. The surface layers are composed of fiber-reinforced plastic.

### SUMMARY

In an embodiment, the present disclosure provides a ducted fan for an aircraft. The ducted fan includes a rotor-side fan and a stator-side duct that surrounds the rotor-side fan radially at an outside and that defines a flow channel for air flowing via the fan. The stator-side duct includes an inner wall facing the rotor-side fan and an outer wall averted from the fan. The inner wall includes at least one layer composed of fiber-reinforced plastic, and the outer wall includes at least one layer composed of fiber-reinforced plastic. At least two honeycomb cores are arranged between the inner wall and the outer wall of the stator-side duct, the at least two honeycomb cores abutting against one another in an axial direction of the ducted fan. The honeycombs of the at least two honeycomb cores extend at least substantially in a radial direction of the ducted fan. A first of the at least two honeycomb cores is, at least in a region of an abutting surface that adjoins another of the at least two honeycomb cores, enwound or encased by at least one layer composed of fiber-reinforced plastic.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a side view of an aircraft;

FIG. 2 shows a plan view of the aircraft;

FIG. 3 shows a perspective view of a ducted fan of the aircraft together with slat units;

FIG. 4 shows a perspective view of a duct of the ducted fan; and

FIG. 5 shows the cross section V-V of FIG. 4 together with an enlarged detail.

### DETAILED DESCRIPTION

The present disclosure provides a new ducted fan for an aircraft, an aircraft having such a ducted fan, and a component for an aircraft.

The ducted fan has a rotor-side fan and a stator-side duct, which surrounds the fan radially at the outside and defines a flow channel for air flowing via the fan.

The duct has an inner wall which faces toward the fan and which is composed of at least one layer composed of fiber-reinforced plastic. The duct further has an outer wall which is averted from the fan and which is composed of at least one layer composed of fiber-reinforced plastic.

Between the inner wall and the outer wall of the duct, there are arranged at least two honeycomb cores which abut against one another in an axial direction of the ducted fan and the honeycombs of which extend in a radial direction or substantially in the radial direction of the ducted fan.

At least one of the honeycomb cores which abut against one another in the axial direction of the ducted fan is, at least in the region of its respective abutting surface in relation to the respective adjoining honeycomb core, enwound or encased by at least one layer composed of fiber-reinforced plastic.

The ducted fan is of lightweight construction and has high stability and stiffness. This is ensured on the one hand in that, between the inner wall and the outer wall of the duct of the ducted fan, there are arranged at least two honeycomb cores, the honeycombs of which extend in the radial direction of the ducted fan, and on the other hand in that at least one of the honeycomb cores which abut against one another in the axial direction of the ducted fan is, at least in the region of its respective abutting surface, enwound or encased by the at least one layer composed of fiber-reinforced plastic.

A good transmission of force between the inner wall and the outer wall of the duct is ensured.

There is no risk of one of the honeycomb cores which abut against one another collapsing owing to an introduction of force.

Preferably, at least one of the honeycomb cores which abut against one another in the axial direction of the ducted fan is enwound or encased completely by the at least one layer composed of fiber-reinforced plastic. This is particularly preferred in order to ensure a simple production process and for the transmission of force from the inner wall in the direction of the outer wall.

Preferably, of in each case two of the honeycomb cores which abut against one another in the axial direction of the ducted fan, only one of the in each case two honeycomb cores is enwound or encased at least in the region of its abutting surface by the at least one layer composed of fiber-reinforced plastic. This is preferred in order to minimize the outlay on production.

In one advantageous refinement, the duct of the ducted fan has, at one axial position, a notch which receives a run-in body into which rotor blades of the fan of the ducted fan can run during operation, wherein the honeycomb core which is enwound or encased at least in the region of its respective abutting surface by at least one layer composed of fiber-reinforced plastic extends over the entire axial extent of the run-in body. This is particularly preferred for an optimum transmission of force from the inner wall in the direction of the outer wall. In particular where the fan or rotor can run into the run-in body during operation, and where high forces occur during operation, said forces can be transmitted from the inner wall in the direction of the outer wall.

The aircraft is defined in claim 6.

The component of the aircraft, which is in particular the duct of the ducted fan, is defined in claim 8.

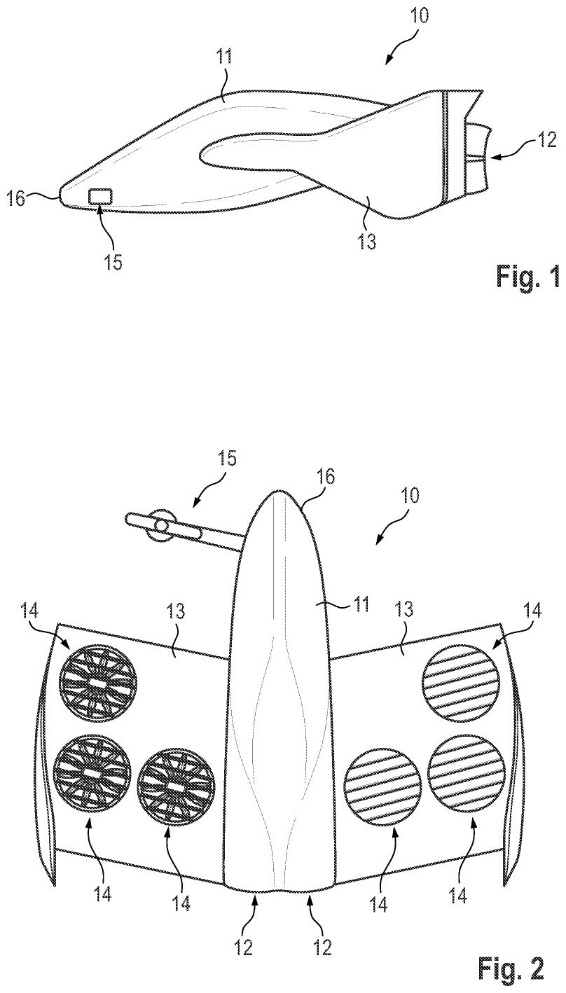

FIGS. 1 and 2 show different views of an aircraft 10. The aircraft has a fuselage 11, which provides, inter alia, a passenger compartment. The aircraft 10 furthermore has wings 13 which engage on the fuselage 11.

The aircraft 10 is a so-called vertical takeoff aircraft which, upon takeoff, lifts off from the ground vertically and, upon landing, lands on the ground vertically.

In order to allow such vertical takeoff and landing of the aircraft 10, the aircraft 10 has in each case at least one wing lift unit 14, also referred to as WLU, at least in the region of each wing 13. In the exemplary embodiment shown, in each case three such wing lift units 14 are provided in each wing 13.

The vertical takeoff and landing of the aircraft 10 that takes place through the use of the wing lift units 14 can be assisted by means of at least one nose lift unit 15 which engages on a nose 16 of the fuselage 11 of the aircraft 10. A nose lift unit 15 is also referred to as NLU. FIGS. 1 and 2 show a nose lift unit 15 of said type which is positioned on one side of the fuselage 11. It is also possible for two such nose lift units 15 to be used. The nose lift units 15 are preferably pivotable relative to the fuselage 11, specifically such that the respective nose lift unit 15 is pivoted out of the fuselage 11 for takeoff and landing, whereas the respective nose lift unit 15 is pivoted into the fuselage 11 for flight operation after takeoff and before landing of the aircraft 10.

For the forward thrust of the aircraft 10 after it has taken off, the aircraft 10 has at least one forward thrust unit 12, in the exemplary embodiment shown two forward thrust units 12, which are integrated into the rear end of the fuselage 11.

Each of a respective wing lift unit 14 and a respective nose lift unit 15 and a respective forward thrust unit 12 of the aircraft 10 may comprise a ducted fan 17.

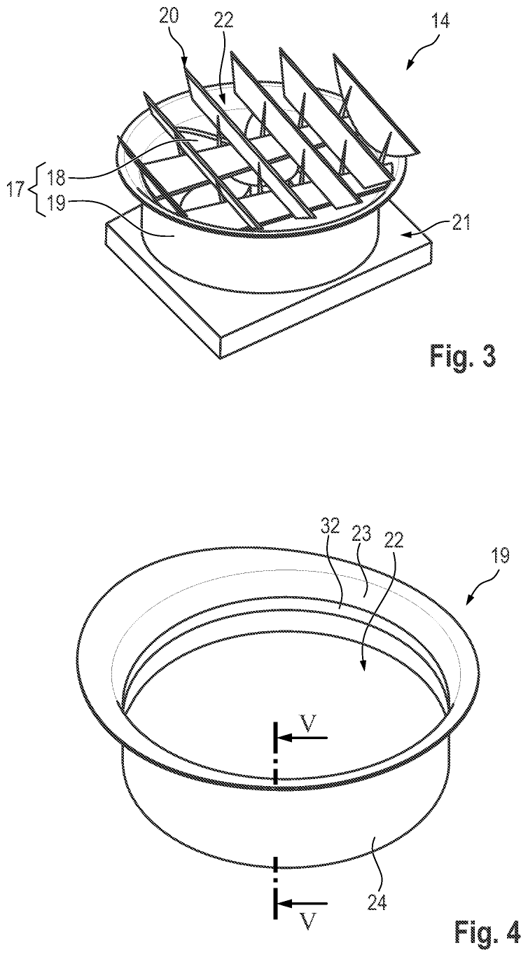

FIG. 3 shows a perspective view of a wing lift unit 14 that comprises a ducted fan 17. Here, the ducted fan 17 has a rotor-side fan 18 and a stator-side duct 19.

Furthermore, FIG. 3 shows slat units 20, 21, specifically an upper slat unit 20 and a lower slat unit 21, as further assemblies of the wing lift unit 14.

For takeoff and landing, the two slat units 20, 21 are opened, and open up a flow channel 22, which is defined by the duct 19 of the ducted fan 17, for a passage of flow.

By contrast, if the wing lift units 14 are not required, in particular during normal flight operation after takeoff and before landing, then the slat units 20, 21 are closed, and close the flow channel 22 of the duct 19 of the respective ducted fan 17.

As already stated, a ducted fan 17 accordingly has the rotor-side fan 18 and the stator-side duct 19. The stator-side duct 19 defines a flow channel for air flowing via the fan 18, wherein said flow channel 22 extends in the axial direction A of the ducted fan 17. As viewed in the radial direction R of the ducted fan 17, the duct 19 surrounds the rotor or fan 18 radially at the outside.

The duct 19 of the ducted fan 17 has an inner wall 23, which faces toward the fan 18 of the ducted fan 17, and an outer wall 24, which is averted from the fan 18. Both the inner wall 23 and the outer wall 24 are composed in each case of at least one layer composed of fiber-reinforced plastic, preferably composed of a carbon-fiber-reinforced plastic or alternatively of a glass-fiber-reinforced plastic. The inner wall 23 of the duct 19 of the ducted fan 17 defines the flow channel 22 of the ducted fan 17 for the air flowing via the rotor 18.

Preferably, both the inner wall 23 and the outer wall 24 of the duct 19 are formed from multiple layers composed of fiber-reinforced plastic, specifically the inner wall 23 of the duct 19 from a first number of layers and the outer wall 24 from a second number of layers, wherein the first number is preferably greater than the second number. It is then the case that more layers composed of fiber-reinforced plastic are laminated to form a wall in the region of the inner wall 23 than in the region of the outer wall 24. It is possible that, in the region of the inner wall 23, three layers composed of fiber-reinforced plastic, and in the region of the outer wall 24, two layers composed of fiber-reinforced plastic, form the corresponding wall 23, 24.

The layers composed of fiber-reinforced plastic that form the inner wall 23 and the outer wall 24 of the duct 19 of the ducted fan 17 are preferably layers composed of multi-directional fiber-reinforced plastic. The fibers of the fiber-reinforced plastic then run in different directions.

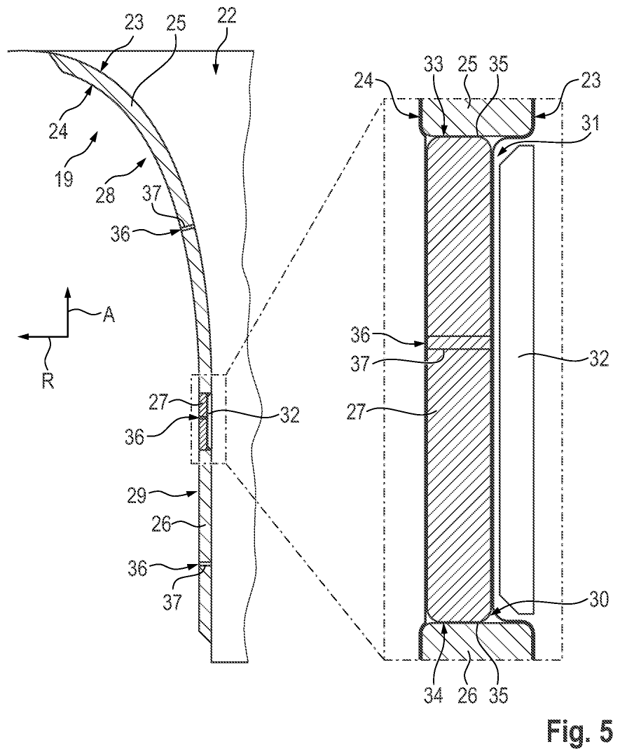

Between the inner wall 23 and the outer wall 24 of the duct 19 of the ducted fan 17, there are arranged at least two, in the exemplary embodiment of FIG. 5 three, honeycomb cores 25, 26 and 27, which abut against one another in an axial direction A of the ducted fan 17. Here, the honeycomb core 27 is arranged between the honeycomb cores 25 and 26 as viewed in the axial direction A and abuts by way of a respective abutting surface 33, 34 at one side against the honeycomb core 25 and at the other side against the honeycomb core 26.

Each of the honeycomb cores 25, 26 and 27 has a multiplicity of honeycombs, wherein the honeycombs extend in a radial direction R or substantially in the radial direction R of the ducted fan 17. In FIG. 5, in each case one honeycomb 36 is shown in the region of each honeycomb core 25, 26, 27. In the case of such honeycombs 36 which extend in the radial direction R, honeycomb walls 37, which define the honeycombs 36, of the respective honeycomb core 25, 26, 27 run in the radial direction R between the inner wall 23 and the outer wall 24. Adjoining the inner wall 23 and the outer wall 24, the honeycombs 36 of the respective honeycomb core 25, 26 and 27 are open.

In an inlet-side section 28 of the duct 19 of the ducted fan 17, in which said duct is contoured with a funnel-like curvature, the honeycombs 36 run substantially in the radial direction R of the duct 19 and thus of the ducted fan 17. The honeycombs 36 are then inclined relative to the radial direction R. By contrast, in an outlet-side section 29 of the duct 19 and thus of the ducted fan 17, the honeycombs 36 of the respective honeycomb body 26, 27 run in the radial direction R. Here, the duct 19 of the ducted fan 17 has a tubular or cylindrical contour.

At least one of the honeycomb cores 25, 26, 27 which abut against one another in the axial direction A of the ducted fan 17 or of the duct 19 thereof is, at least in the region of its respective abutting surface 33, 34 in relation to the respective adjoining honeycomb core, enwound or encased by at least one layer composed of fiber-reinforced plastic.

In the exemplary embodiment shown, in which, as viewed in the axial direction A, three honeycomb cores 25, 26 and 27 are arranged one behind the other or adjacent to one another in the axial direction and in which the honeycomb core 27 adjoins or abuts against both the honeycomb core 25 and the honeycomb core 26, only the honeycomb core 27 is, at least in the region of its abutting surfaces 33, 34 in relation to the adjoining honeycomb cores 25, 26, enwound or encased by at least one layer composed of fiber-reinforced plastic.

It is particularly preferable if at least one of the honeycomb cores which abut against one another, in the exemplary embodiment shown the honeycomb core 27 arranged between the honeycomb cores 25 and 26, is enwound or encased completely by at least one layer composed of fiber-reinforced plastic.

The at least one layer composed of fiber-reinforced plastic for the respective honeycomb core forms an encasement 35 thereof at least in certain sections.

By means of the above enwinding or encasement 35 of at least one of in each case two honeycomb cores 25, 27 or 26, 27 respectively which abut against one another in the axial direction of the ducted fan 17, it is possible on the one hand to ensure high stiffness and thus stability of the duct 19 of the ducted fan 17, and on the other hand, a collapse of a honeycomb core owing to a force acting thereon is prevented. This risk exists in particular in the event of a force acting in the region of the abutting surfaces of honeycomb cores that adjoin one another.

From FIG. 5, specifically the detail of FIG. 5, it can be seen that the honeycomb core 27 that is arranged between the honeycomb cores 25, 26 is enwound or encased completely by an encasement 35 which is composed of at least one layer composed of fiber-reinforced plastic, in particular composed of carbon-fiber-reinforced plastic or alternatively composed of glass-fiber-reinforced plastic. In this case, too, this is preferably multidirectionally fiber-reinforced plastic, in the case of which fibers thereof run in different directions.

As per FIGS. 4 and 5, the duct 19 of the ducted fan 17 has, at one axial position, a notch 31 which receives a run-in body 32. Said run-in body 32 is preferably a foam body, wherein rotor blades of the rotor or fan 18 of the ducted fan 17 can run into said run-in body 32 during operation, in order that the rotor blades of the rotor or fan 18 are not damaged during operation.

That honeycomb core 27 which is enwound or encased at least in certain sections by at least one layer composed of fiber-reinforced plastic extends in this case in the region of the duct 19 over the entire axial extent of the run-in body 32. Here, as already stated, the honeycomb body 27 which is arranged radially outside the run-in body 32 is preferably encased completely by the at least one layer composed of fiber-reinforced plastic in order to optimally transmit forces from the inner wall 23 in the direction of the outer wall 24.

The disclosure relates not only to the above-described ducted fan 17 but also to the duct 19 of the ducted fan 17 per se. The duct 19 of the ducted fan 17 is a component of an aircraft, having a first wall 23 composed of at least a first layer composed of fiber-reinforced plastic and at least one second wall 24 composed of at least one layer composed of fiber-reinforced plastic, wherein, between said two walls 23, 24, there are arranged at least two honeycomb cores, the honeycombs 36 of which extend between the first wall 23 and the second wall 24 and which abut against one another perpendicularly with respect to the extent direction of the honeycombs 36. As stated above, at least one of in each case two honeycomb cores which abut against one another is enwound or encased, at least in the region of its respective abutting surface 33, 34 relative to an adjoining honeycomb core, by at least one layer composed of fiber-reinforced plastic, wherein said honeycomb core is preferably encased or enwound completely by the at least one layer composed of fiber-reinforced plastic.

The disclosure also relates to the aircraft 10. The aircraft 10 has the above-described fuselage 11 and the wings 13 that engage on the fuselage 11. Furthermore, the aircraft 10 has at least one ducted fan 17 according to the invention.

The ducted fan 17 may engage on the wing 13 as a constituent part of a wing lift unit 14 or on the nose 16 of the fuselage 11 as a constituent part of a nose lift unit 15.

The forward thrust unit 12 may also have a ducted fan 17.

The respective ducted fan 17 is designed as described in detail above.

In particular, the ducted fan 17 engages on a respective wing 13 as a constituent part of a wing lift unit 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A ducted fan for an aircraft, the ducted fan comprising:
a rotor-side fan,
a stator-side duct that surrounds the rotor-side fan radially at an outside and defines a flow channel for air flowing via the fan, the stator-side duct comprising:
an inner wall facing the rotor-side fan, the inner wall including at least one layer composed of fiber-reinforced plastic, and
an outer wall averted from the fan, the outer wall including at least one layer composed of fiber-reinforced plastic,
at least two honeycomb cores arranged between the inner wall and the outer wall of the stator-side duct, the at least two honeycomb cores abutting against one another in an axial direction of the ducted fan, wherein the honeycombs of the at least two honeycomb cores extend at least substantially in a radial direction of the ducted fan,
wherein a first of the at least two honeycomb cores is, at least in a region of an abutting surface that adjoins another of the at least two honeycomb cores, enwound or encased by at least one layer composed of fiber-reinforced plastic.

2. The ducted fan as claimed in claim 1, wherein the first of the at least two honeycomb cores is enwound or encased completely by the at least one layer composed of fiber-reinforced plastic.

3. The ducted fan as claimed in claim 1, wherein, for each respective pair of honeycomb cores of the at least two honeycomb cores, only one honeycomb core of the respective pair of honeycomb cores is enwound or encased by a respective layer composed of fiber-reinforced plastic in a region of an abutting surface that adjoins the pair of honeycomb cores.

4. The ducted fan as claimed in claim 1, wherein the inner wall of the duct is formed from a first number of layers of fiber-reinforced plastic, the outer wall of the duct is formed from a second number of layers of fiber-reinforced plastic, and
wherein the first number is greater than the second number.

5. The ducted fan as claimed in claim 1, wherein the duct has, at one axial position, a notch that receives a run-in body into which rotor blades of the fan are configured to run during operation, wherein the first honeycomb core extends over the entire axial extent of the run-in body.

6. An aircraft, comprising:
a fuselage that provides a passenger compartment,
wings that engage on the fuselage,
the ducted fan according to claim 1, wherein the ducted fan engages on the fuselage or on the wings.

7. The aircraft as claimed in claim 6, wherein the ducted fan engages on a wing.

8. A component for an aircraft, the component comprising:
a first wall composed of at least one layer composed of fiber-reinforced plastic,
a second wall composed of at least one layer composed of fiber-reinforced plastic, and
at least two honeycomb cores arranged between the first wall and the second wall, wherein honeycombs of the at least two honeycomb cores extend between the first wall and the second wall and abut against one another perpendicularly with respect to an extent direction of the honeycombs,
wherein a first of the at least two honeycomb cores is, at least in a region of an abutting surface that adjoins another of the at least two honeycomb cores, enwound or encased by at least one layer composed of fiber-reinforced plastic.

9. The component as claimed in claim 8, wherein the first of the at least two honeycomb cores is enwound or encased completely by the at least one layer composed of fiber-reinforced plastic.

10. The component as claimed in claim 8, wherein, for each respective pair of honeycomb cores of the at least two honeycomb cores, only one honeycomb core of the respective pair of honeycomb cores is enwound or encased by a respective layer composed of fiber-reinforced plastic in a region of an abutting surface that adjoins the pair of honeycomb cores.
